(19) United States
(12) Patent Application Publication
(10) Pub. No.: US 2021/0166418 A1
(43) Pub. Date: Jun. 3, 2021

(54) OBJECT POSTURE ESTIMATION METHOD AND APPARATUS

(71) Applicant: SHENZHEN SENSETIME TECHNOLOGY CO., LTD., Shenzhen (CN)

(72) Inventors: Tao ZHOU, Shenzhen (CN); Hui CHENG, Shenzhen (CN)

(21) Appl. No.: 17/172,847

(22) Filed: Feb. 10, 2021

Related U.S. Application Data
(63) Continuation of application No. PCT/CN2019/121068, filed on Nov. 26, 2019.

(30) Foreign Application Priority Data
Feb. 23, 2019 (CN) 201910134640.4

(51) Int. Cl. G06T 7/73; B25J 19/02

(52) U.S. Cl. CPC G06T 7/73; B25J 19/023; G06T 2207/10028; G06T 2207/20081; G06T 2207/20084

(57) ABSTRACT

Provided are an object posture estimation method and apparatus. The method includes: obtaining point cloud data of an object, where the point cloud data includes at least one point; inputting the point cloud data of the object into a pre-trained point cloud neural network to obtain a predicted posture of the object to which the at least one point belongs; performing clustering processing on the predicted posture of the object to which the at least one point belongs to obtain at least one clustering set; and obtaining the posture of the object according to predicted postures of at least one objects included in the at least one clustering set, where the posture includes a position and an attitude angle.

### CROSS REFERENCE TO RELATED APPLICATIONS

The present application is a continuation of International Patent Application No. PCT/CN2019/121068, filed on Nov. 26, 2019, which claims priority to Chinese Patent Application No. 201910134640.4, filed on Feb. 23, 2019. The content of International Patent Application No. PCT/CN2019/121068 and Chinese Patent Application No. 201910134640.4 is hereby incorporated by reference in their entireties.

### BACKGROUND

With the deepening of robotics research and the increasing demands in various aspects, robots are applied more and more extensively, for example, grabbing objects stacked in a material box by a robot. Grabbing the stacked objects by the robot includes first identifying a posture of a to-be-grabbed object in a space, and then grabbing the to-be-grabbed object according to the identified posture. The conventional method includes: first extracting feature points from an image, then performing feature matching on the image and a preset reference image to obtain matched feature points, determining a position of the to-be-grabbed object in a camera coordinate system according to the matched feature points, and calculating the posture of the object according to calibration parameters of a camera.

### SUMMARY

The present disclosure relates to the field of machine vision technologies, and in particular, to an object posture estimation method and apparatus.

According to a first aspect of embodiments of the present disclosure, provided is an object posture estimation method, which includes: obtaining point cloud data of an object, where the point cloud data includes at least one point; inputting the point cloud data of the object into a pre-trained point cloud neural network to obtain a predicted posture of the object to which the at least one point belongs; performing clustering processing on the predicted posture of the object to which the at least one point belongs to obtain at least one clustering set; and obtaining the posture of the object according to predicted postures of the at least one object included in the at least one clustering set, where the posture includes a position and an attitude angle.

According to a second aspect of the embodiments of the present disclosure, provided is an object posture estimation apparatus, which includes: a processor and a memory for storing instructions executable by the processor, where the processor is configured to execute the instructions to implement the method as described in the first aspect of the present disclosure.

According to a third aspect of the embodiments of the present disclosure, provided is a computer-readable storage medium, having a computer program stored thereon, where the computer program includes program instructions that, when executed by a processor of a batch processing apparatus, cause the processor to execute the method according to any item in the first aspect.

### BRIEF DESCRIPTION OF THE DRAWINGS

The accompanying drawings herein are incorporated into the specification and constitute a part of the specification. These accompanying drawings show embodiments that conform to the present disclosure, and are intended to describe the technical solutions in the present disclosure together with the specification.

FIG. 1 is a schematic flowchart of an object posture estimation method provided in embodiments of the present disclosure;

FIG. 2 is a schematic flowchart of another object posture estimation method provided in embodiments of the present disclosure;

FIG. 3 is a schematic flowchart of another object posture estimation method provided in embodiments of the present disclosure;

FIG. 4 is a schematic flowchart of object posture estimation-based object grabbing provided in embodiments of the present disclosure;

FIG. 5 is a schematic structural diagram of an object posture estimation apparatus provided in embodiments of the present disclosure; and

FIG. 6 is a schematic structural diagram of hardware of an object posture estimation apparatus provided in embodiments of the present disclosure.

### DETAILED DESCRIPTION

To make a person skilled in the art better understand the solutions of the present disclosure, the technical solutions in the embodiments of the present disclosure are clearly and fully described below with reference to the accompanying drawings in the embodiments of the present disclosure. Apparently, the described embodiments are merely some of the embodiments of the present disclosure, but not all the embodiments. Based on the embodiments of the present disclosure, all other embodiments obtained by a person of ordinary skill in the art without involving an inventive effort shall fall within the scope of protection of the present disclosure.

The terms “first”, “second”, and the like in the specification, the claims, and the accompanying drawings in the present disclosure are used for distinguishing different objects, rather than describing specific sequences. In addition, the terms “include” and “have” and any deformation thereof aim at covering non-exclusive inclusion. For example, the process, method, system, product, or device including a series of steps or units is not limited to the listed steps or units, but optionally includes steps or units that are not listed, or optionally includes other steps or units inherent to the process, method, product, or device.

Reference herein to “embodiments” means that a particular feature, structure, or characteristic described in combination with the embodiments may be included in at least one embodiment of the present disclosure. The appearances of this phrase in different parts of the specification are not necessarily all referring to the same embodiment, or are separate or alternative embodiments mutually exclusive of other embodiments. The embodiments described herein, explicitly and implicitly understood by a person skilled in the art, may be combined with other embodiments.

In the industrial field, to-be-assembled parts are generally placed in a material box or a material tray, and the assembly of the parts placed in the material box or the material tray is an important part in the assembly process. The manual assembly mode is low in efficiency due to a large number of to-be-assembled parts, and the labor costs are high. In the present disclosure, the parts in the material box or the material tray are identified by means of a point cloud neural network, so that posture information of the to-be-assembled parts is automatically obtained, and then a robot or mechanical arm may complete the grabbing and assembly of the to-be-assembled parts according to the posture information of the to-be-assembled parts.

To describe the technical solutions in embodiments of the present disclosure or the background art more clearly, the accompanying drawings required for describing the embodiments of the present disclosure or the background art are described below.

The embodiments of the present disclosure are described below with reference to the accompanying drawings in the embodiments of the present disclosure. Execution of the method steps provided in the present disclosure may be performed by hardware, or by a processor by running computer-executable codes.

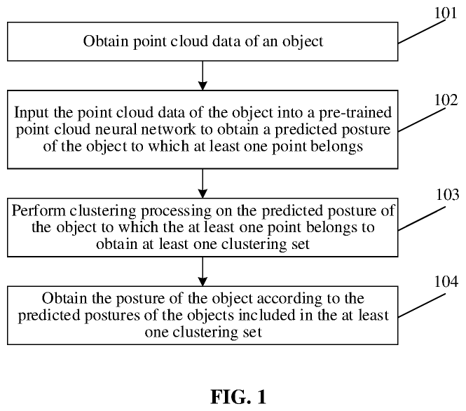

Referring to FIG. 1, FIG. 1 is a schematic flowchart of an object posture estimation method provided in embodiments of the present disclosure.

At block 101, point cloud data of an object is obtained.

In the embodiments of the present disclosure, the point cloud data of the object is processed to obtain the posture of the object. In one possible implementation for obtaining the point cloud data of the object, the object is scanned by means of a three-dimensional laser scanner, and when laser light irradiates the surface of the object, the reflected laser light carries information such as orientation and distance. A laser beam scans according to a certain trajectory, and reflected laser point information is recorded during scanning Since the scanning is very fine, a large number of laser points may be obtained, and then the point cloud data of the object is obtained.

At block 102, the point cloud data of the object is input into a pre-trained point cloud neural network to obtain a predicted posture of the object to which the at least one point belongs.

The point cloud data of the object is input into the pre-trained point cloud neural network, a position of a reference point of the object to which each point in the point cloud data belongs as well as an attitude angle of the object are predicted to obtain a predicted posture of each object, and the predicted posture is presented in the form of a vector, where the predicted posture of the object includes a predicted position and a predicted attitude angle of the reference point of the object, and the reference point includes at least one of the center of mass, the center of gravity, or the center.

The point cloud neural network is pre-trained. In one possible implementation, a method for training the point cloud neural network includes: obtaining point cloud data and tag data of an object; performing feature extraction processing on the point cloud data of the object to obtain feature data; performing first linear transformation on the feature data to obtain a predicted displacement vector of a position of the reference point of the object to which the point belongs to a position of the point; obtaining a predicted position of the reference point of the object to which the point belongs according to the position of the point and the predicted displacement vector; performing second linear transformation on the feature data to obtain a predicted attitude angle of the reference point of the object to which the point belongs; performing third linear transformation on the feature data to obtain a category identification result of the object corresponding to a point in the point cloud data; performing clustering processing on the predicted posture of the object to which the at least one point belongs to obtain at least one clustering set, where the predicted posture includes a predicted position of the reference point of the object to which the point belongs as well as a predicted attitude angle of the reference point of the object to which the point belongs; obtaining the posture of the object according to the predicted postures of the objects included in the at least one clustering set, where the posture includes a position and an attitude angle; obtaining a classification loss function value according to a classification loss function, the object category prediction result, and the tag data; obtaining a posture loss function value according to a posture loss function, the posture of the object, and a posture tag of the object, where the expression of the posture loss function is: L=Σ∥R_{P}−R_{GT}∥², where R_{P} is a posture of the object, R_{GT} is a tag of the pose, and Σ is the sum of a point cloud posture loss function of the at least one point; obtaining a point-by-point cloud loss function value according to a point-by-point cloud loss function, a visibility prediction loss function, the classification loss function value, and the posture loss function value; and adjusting a weight of the point cloud neural network, so that the point-by-point cloud loss function value is less than a threshold, and obtaining a trained point cloud neural network.

It should be understood that the present disclosure does not limit the specific forms of the classification loss function and a total loss function. The trained point cloud neural network may predict a position of a reference point of the object to which each point in the point cloud data of the object belongs as well as an attitude angle of the object to which each point belongs, and a predicted value of the position and a predicted value of the attitude angle are presented in the form of vectors. Moreover, the category of the object to which a point in the point cloud belongs is also given.

At block 103, clustering processing is performed on the predicted posture of the object to which the at least one point belongs to obtain at least one clustering set.

Clustering processing is performed on the predicted posture of the object to which the point in the point cloud data of the object belongs to obtain at least one clustering set, and each clustering set corresponds to one object. In one possible implementation, clustering processing is performed on the predicted posture of the object to which the point in the point cloud data of the object belongs by means of a mean drift clustering algorithm to obtain at least one clustering set.

At block 104, the posture of the object is obtained according to the predicted postures of the objects included in the at least one clustering set.

Each clustering set includes a plurality of points, each having a predicted value of the position and a predicted value of the attitude angle. In one possible implementation, an average value of the predicted values of the positions of the points included in the clustering set is calculated, and the average value of the predicted values of the positions is taken as the position of the reference point of the object. An average value of the predicted values of the attitude angles of the points included in the clustering set is calculated, and the average value of the predicted values of the attitude angles is taken as the attitude angle of the object.

Optionally, by means of the operations of 101-104, the posture of at least one of the stacked objects in any scene may be obtained. Because the grabbed points of the objects are preset, under the condition that the position of the reference point of the object under a camera coordinate system and the attitude angle of the object are obtained, an adjustment angle of a robot end effector is obtained according to the attitude angle of the object; the position of the grabbed point under the camera coordinate system is obtained according to a positional relationship between the reference point and the grabbed point of the object; the position of the grabbed point under a robot coordinate system is obtained according to a hand-eye calibration result of a robot (i.e., the position of the grabbed point under the camera coordinate system); path planning is performed according to the position of the grabbed point under the robot coordinate system, so as to obtain a traveling route of the robot; and the adjustment angle and the traveling route are taken as a control instruction, to control the robot to grab at least one of the stacked objects. In embodiments of the present disclosure, point cloud data of an object is processed by means of a point cloud neural network; a position of a reference point of the object to which each point in the point cloud data of the object belongs as well as an attitude angle of the object to which each point belongs are predicted; then, clustering processing is performed on a predicted posture of the object to which the point in the point cloud data of the object belongs to obtain a clustering set; and the position of the reference point of the object and the attitude angle of the object are obtained by calculating an average value of predicted values of the positions and an average value of predicted values of the attitude angles of the points included in the clustering set.

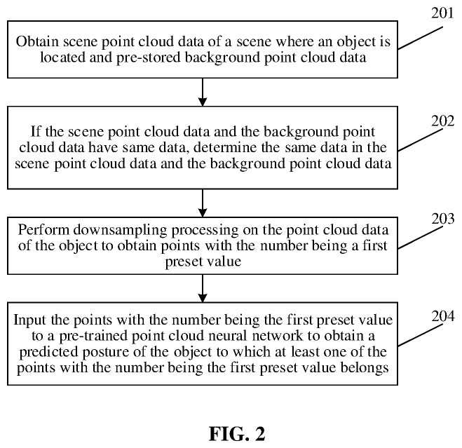

Referring to FIG. 2, FIG. 2 is a schematic flowchart of an object posture estimation method provided in embodiments of the present disclosure.

At block 201, scene point cloud data of a scene where the object is located and pre-stored background point cloud data are obtained.

Since the objects are placed in the material box or the material tray, and all objects are stacked, the point cloud data of the objects in the stacked state cannot be directly obtained. The point cloud data (i.e., the pre-stored background point cloud data) of the material box or the material tray is obtained, the point cloud data (i.e., the scene point cloud data of the scene where the object is located) of the material box or the material tray where the object is placed is obtained, and point cloud data of the object is obtained by means of the two point cloud data. In one possible implementation, the scene where the object is located (the material box or the material tray) is scanned by means of a three-dimensional laser scanner, and when laser light irradiates the surface of the material box or the material tray, the reflected laser light carries information such as orientation and distance. A laser beam scans according to a certain trajectory, and reflected laser point information is recorded during scanning Since the scanning is very fine, a large number of laser points may be obtained, and then the background point cloud data is obtained. Then, the object is placed in the material box or the material tray, and the scene point cloud data of the scene where the object is located is obtained by means of three-dimensional laser scanning.

It should be understood that there is at least one object, and the objects may be the same type of objects or different types of objects. When the object is placed in the material box or the material tray, no specific placement order is required, and all objects may be arbitrarily stacked in the material box or the material tray. In addition, the order of obtaining the scene point cloud data of the scene where the object is located and obtaining the pre-stored background point cloud data is not specifically limited in the present disclosure.

At block 202, if the scene point cloud data and the background point cloud data have same data, the same data in the scene point cloud data and the background point cloud data is determined.

The point cloud data includes a large number of points, and thus the calculation amount of point cloud data processing is very large. Therefore, only the point cloud data of the object is processed, which reduces the calculation amount and increases the processing speed. First, whether the scene point cloud data and the background point cloud data have same data is determined, and if yes, the same data is removed from the scene point cloud data to obtain the point cloud data of the object.

At block 203, down-sampling processing is performed on the point cloud data of the object to obtain points with the number being a first preset value.

As described above, the point cloud data includes a large number of points. Even through the operation of 202 where the calculation amount is reduced, since the point cloud data of the object still includes a large number of points, if the point cloud data of the object is directly processed by means of the point cloud neural network, the calculation amount is still very large. In addition, due to the limit of configuration of hardware running the point cloud neural network, the large calculation amount may affect the speed of subsequent processing, and even normal processing cannot be performed. Therefore, the number of points in the point cloud data of the object input to the point cloud neural network needs to be limited. The number of points in the point cloud data of the object is reduced to the first preset value, and the first preset value may be adjusted according to the specific hardware configuration. In one possible implementation, random sampling processing is performed on the point cloud data of the object to obtain points with the number being the first preset value. In another possible implementation, farthest point sampling processing is performed on the point cloud data of the object to obtain points with the number being the first preset value. In yet another possible implementation, uniform sampling processing is performed on the point cloud data of the object to obtain points with the number being the first preset value.

At block 204, the points with the number being the first preset value are input to the pre-trained point cloud neural network to obtain a predicted posture of the object to which at least one of the points with the number being the first preset value belongs.

The points with the number being the first preset value are input to the point cloud neural network. Feature extraction processing is performed on the points with the number being the first preset value by means of the point cloud neural network, so as to obtain feature data. In one possible implementation, convolution processing is performed on the points with the number being the first preset value by means of a convolutional layer in the point cloud neural network, so as to obtain the feature data.

The feature data obtained by the feature extraction processing is input to the fully connected layer. It should be understood that there may be a plurality of fully connected layers. Since different fully connected layers have different weights after the point cloud neural network is trained, the results obtained after the feature data is processed by means of different fully connected layers are different. First linear transformation is performed on the feature data to obtain a predicted displacement vector of a position of the reference point of the object to which the points with the number being the first preset value belong to positions of the points. A predicted position of the reference point of the object to which the points belong is obtained according to the positions of the points and the predicted displacement vector, that is, by predicting the displacement vector of each point to the reference point of the object as well as the position of the point, the position of the reference point of the object to which each point belongs is obtained, so that the range of the predicted value of the position of the reference point of the object to which each point belongs becomes relatively uniform, and the convergence property of the point cloud neural network is better. Second linear transformation is performed on the feature data to obtain a predicted value of the attitude angle of the object to which the points with the number being the first preset value belong. Third linear transformation is performed on the feature data to obtain a category of the object to which the points with the number being the first preset value belong. In one possible implementation, weights of different pieces of feature data output by the convolutional layer are determined according to the weight of the first fully connected layer, and first weighted superposition is performed to obtain a predicted value of the position of the reference point of the object to which the points with the number being the first preset value belong. Second weighted superposition is performed on different pieces of feature data output by the convolutional layer according to the weight of the second fully connected layer, so as to obtain a predicted value of the attitude angle of the object to which the points with the number being the first preset value belong. The weights of different pieces of feature data output by the convolutional layer are determined according to the weight of the third fully connected layer, and third weighted superposition is performed to obtain a category of the object to which the points with the number being the first preset value belong.

In the embodiments of the present disclosure, the point cloud neural network is trained, so that the trained point cloud neural network may identify the position of the reference point of the object to which the point in the point cloud data belongs as well as the attitude angle of the object based on the point cloud data of the object.

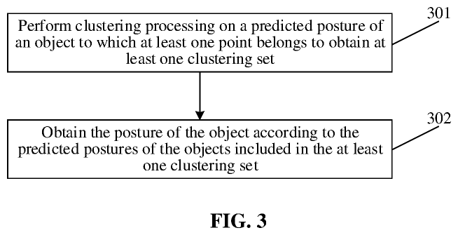

Referring to FIG. 3, FIG. 3 is a schematic flowchart of another object posture estimation method provided in embodiments of the present disclosure.

At block 301, clustering processing is performed on the predicted posture of the object to which the at least one point belongs to obtain at least one clustering set.

By means of the processing of the point cloud neural network, each point in the point cloud data of the object has a corresponding prediction vector. Each prediction vector includes: a predicted value of the position of the object to which the point belongs as well as a predicted value of the attitude angle. Since the postures of different objects are necessarily not coincident in space, the resulting prediction vectors of points belonging to different objects are different greatly, while the resulting prediction vectors of points belonging to the same object are substantially the same. Therefore, the points in the point cloud data of the object are divided based on the predicted posture of the object to which the at least one point belongs and a clustering processing method, so as to obtain a corresponding clustering set. In one possible implementation, any point from the point cloud data of the object is taken as a first point; a first to-be-adjusted clustering set is constructed by taking the first point as the center of sphere and a second preset value as a radius; the first point is taken as a starting point and a point other than the first point in the first to-be-adjusted clustering set is taken as an ending point to obtain first vectors, and the first vectors are summed to obtain a second vector; and if a modulus of the second vector is less than or equal to a threshold, the first to-be-adjusted clustering set is taken as the clustering set; if the modulus of the second vector is greater than the threshold, the first point is moved along the second vector to obtain a second point; a second to-be-adjusted clustering set is constructed by taking the second point as the center of sphere and the second preset value as a radius; third vectors are summed to obtain a fourth vector, where a starting point of the third vector is the second point and an ending point of the third vector is the point other than the second point in the second to-be-adjusted clustering set; if a modulus of the fourth vector is less than or equal to the threshold, the second to-be-adjusted clustering set is taken as the clustering set; and if the modulus of the fourth vector is greater than the threshold, the steps of constructing the second to-be-adjusted clustering set are repeated until the modulus of the sum of vectors of points other than the center of sphere to the center of sphere in a newly constructed to-be-adjusted clustering set is less than or equal to the threshold, the to-be-adjusted clustering set is taken as the clustering set. At least one clustering set is obtained by means of the clustering processing, each clustering set having the center of sphere. If the distance between any two centers of sphere is less than a second threshold, the clustering sets corresponding to the two centers of sphere are merged into one clustering set.

It should be understood that the predicted posture of the object to which the at least one point belongs may be clustered by other clustering methods in addition to the above-described achievable clustering processing method, such as a density-based clustering method, a partitioning-based clustering method, and a network-based clustering method. No specific limitation is made thereto in the present disclosure.

At block 302, the posture of the object is obtained according to the predicted postures of the objects included in the at least one clustering set.

The obtained clustering set includes a plurality of points, each having a predicted value of the position of the reference point of the object to which the point belongs as well as a predicted value of the attitude angle of the object to which the point belongs, and each clustering set corresponds to one object. An average value of predicted values of the positions of the reference points of the objects to which the points in the clustering set belong is calculated, and the average value of the predicted values of the positions is taken as the position of the reference point of the corresponding object in the clustering set. An average value of predicted values of the attitude angles of the objects to which the points in the clustering set belong is calculated, and the average value of the predicted values of the attitude angles is taken as the attitude angle of the corresponding object in the clustering set, so as to obtain the posture of the object.

The posture of the object obtained in this method is low in accuracy. The posture of the object is corrected and the corrected posture is taken as the posture of the object, thereby improving the accuracy of the obtained posture of the object. In one possible implementation, a three-dimensional model of the object is obtained and placed in a simulation environment. An average value of the predicted values of the positions of the reference points of the objects to which the points in the clustering set belong is taken as the position of the reference point of the three-dimensional model. An average value of the predicted values of the attitude angles of the objects to which the points in the clustering set belong is taken as the attitude angle of the three-dimensional model. Then, the position of the three-dimensional model is adjusted according to an iterative closest point algorithm, the three-dimensional model, and the point cloud of the object, so that the coincidence degree between the three-dimensional model and an area of the object in the corresponding position in the point cloud data of the object reaches a third preset value. The position of the reference point of the three-dimensional model subjected to position adjustment is taken as the position of the reference point of the object, and the attitude angle of the adjusted three-dimensional model is taken as the attitude angle of the object.

In the embodiments of the present disclosure, clustering processing is performed on the point cloud data of the object based on the posture of the object to which at least one point output by the point cloud neural network belongs, so as to obtain the clustering set; and then, the position of the reference point of the object and the attitude angle of the object are obtained according to the average value of the predicted values of the positions of the reference points of the objects to which the points included in the clustering set belong as well as the average value of the predicted values of the attitude angles.

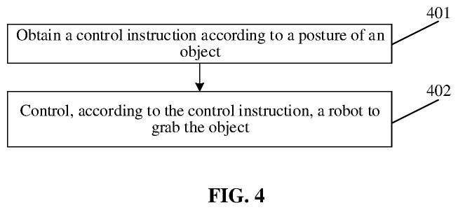

Referring to FIG. 4, FIG. 4 is a schematic flowchart of object posture estimation-based object grabbing provided in embodiments of the present disclosure.

At block 401, a control instruction is obtained according to the posture of the object.

By means of the operations of embodiments 2 (201-204) and 3 (301-302), the postures of the stacked objects in any scene may be obtained. Because the grabbed points of the objects are preset, under the condition that the position of the reference point of the object under a camera coordinate system and the attitude angle of the object are obtained, an adjustment angle of the robot end effector is obtained according to the attitude angle of the object; the position of the grabbed point under the camera coordinate system is obtained according to a positional relationship between the reference point and the grabbed point of the object; the position of the grabbed point under a robot coordinate system is obtained according to a hand-eye calibration result of a robot (i.e., the position of the grabbed point under the camera coordinate system); path planning is performed according to the position of the grabbed point under the robot coordinate system, so as to obtain a traveling route of the robot; and the adjustment angle and the traveling route are taken as a control instruction.

At block 402, the robot is controlled according to the control instruction to grab the object.

The control instruction is sent to the robot, and the robot is controlled to grab and assemble the object. In one possible implementation, the adjustment angle of the robot end effector is obtained according to the attitude angle of the object, and the robot end effector is controlled to be adjusted according to the adjustment angle. The position of the grabbed point is obtained according to the position of the reference point of the object as well as the positional relationship between the grabbed point and the reference point. The position of the grabbed point is converted by means of the hand-eye calibration result, so as to obtain the position of the grabbed point under the robot coordinate system. Path planning is performed based on the position of the grabbed point under the robot coordinate system, so as to obtain a traveling route of the robot, and the robot is controlled to move according to the traveling route. The object is grabbed and then assembled by the end effector.

In the embodiments of the present disclosure, based on the posture of the object, the robot is controlled to grab and assemble the object.

The following embodiments relate to a method for training the point cloud neural network provided in the embodiments of the present disclosure.

The method includes: obtaining point cloud data and tag data of an object; performing feature extraction processing on the point cloud data of the object to obtain feature data; performing first linear transformation on the feature data to obtain a predicted displacement vector of a position of the reference point of the object to which the point belongs to a position of the point; obtaining a predicted position of the reference point of the object to which the point belongs according to the position of the point and the predicted displacement vector; performing second linear transformation on the feature data to obtain a predicted attitude angle of the reference point of the object to which the point belongs; performing third linear transformation on the feature data to obtain a category identification result of the object corresponding to a point in the point cloud data; performing clustering processing on the predicted posture of the object to which the at least one point belongs to obtain at least one clustering set, where the predicted posture includes a predicted position of the reference point of the object to which the point belongs as well as a predicted attitude angle of the reference point of the object to which the point belongs; obtaining the posture of the object according to the predicted postures of the objects included in the at least one clustering set, where the posture includes a position and an attitude angle; obtaining a classification loss function value according to a classification loss function, the object category prediction result, and the tag data; obtaining a posture loss function value according to a posture loss function, the posture of the object, and a posture tag of the object, where the expression of the posture loss function is: L=Σ∥R_{P}−R_{GT}, where R_{P} is a posture of the object, R_{GT} is a tag of the pose, and Σ is summation of a posture loss function of the at least one point in the point cloud data; obtaining a point-by-point cloud loss function value according to a point-by-point cloud loss function, a visibility prediction loss function, the classification loss function value, and the posture loss function value; and adjusting a weight of the point cloud neural network, so that the point-by-point cloud loss function value is less than a threshold, and obtaining a trained point cloud neural network.

The methods according to the embodiments of the present disclosure are described above in detail, and the apparatus according to the embodiments of the present disclosure is provided below.

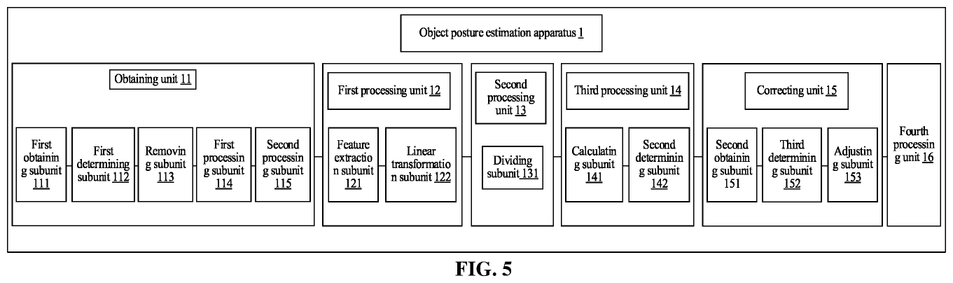

Referring to FIG. 5, FIG. 5 is a schematic structural diagram of an object posture estimation apparatus provided in embodiments of the present disclosure. The apparatus 1 includes: an obtaining unit 11, a first processing unit 12, a second processing unit 13, a third processing unit 14, a correcting unit 15, and a fourth processing unit 16.

The obtaining unit 11 is configured to obtain point cloud data of an object, where the point cloud data includes at least one point.

The first processing unit 12 is configured to input the point cloud data of the object into a pre-trained point cloud neural network to obtain a predicted posture of the object to which the at least one point belongs.

The second processing unit 13 is configured to perform clustering processing on the predicted posture of the object to which the at least one point belongs to obtain at least one clustering set.

The third processing unit 14 is configured to obtain the posture of the object according to the predicted postures of the objects included in the at least one clustering set, where the posture includes a position and an attitude angle.

The correcting unit 15 is configured to correct the posture of the object and take the corrected posture as the posture of the object.

The fourth processing unit 16 is configured to input the point cloud data of the object to the point cloud neural network to obtain a category of the object to which the point in the point cloud data belongs.

Further, the posture of the object includes a posture of a reference point of the object. The posture of the object includes a position and an attitude angle of the reference point of the object, and the reference point includes at least one of the center of mass, the center of gravity, or the center.

Further, the first processing unit 12 includes: a feature extraction subunit 121, configured to perform feature extraction processing on the at least one point to obtain feature data; and a linear transformation subunit 122, configured to perform linear transformation on the feature data to obtain the predicted posture of the object to which the at least one point respectively belongs.

Further, the predicted posture of the object includes a predicted position and a predicted attitude angle of the reference point of the object. The linear transformation subunit 122 is further configured to: perform first linear transformation on the feature data to obtain a predicted displacement vector of a position of the reference point of the object to which the point belongs to a position of the point; obtain a predicted position of the reference point of the object to which the point belongs according to the position of the point and the predicted displacement vector; and perform second linear transformation on the feature data to obtain a predicted attitude angle of the reference point of the object to which the point belongs.

Further, the point cloud neural network includes a first fully connected layer. The linear transformation subunit 122 is further configured to: obtain a weight of the first fully connected layer; perform weighted superposition on the feature data according to the weight of the first fully connected layer to obtain the predicted displacement vector of the position of the reference point of the object to which the point belongs to the position of the point; and obtain a predicted position of the reference point of the object to which the point belongs according to the position of the point and the predicted displacement vector.

Further, the point cloud neural network includes a second fully connected layer. The linear transformation subunit 122 is further configured to: obtain a weight of the second fully connected layer; and perform weighted superposition on the feature data according to the weight of the second fully connected layer to obtain the predicted attitude angles of the respective objects.

Further, the obtaining unit 11 includes: a first obtaining subunit 111, configured to obtain scene point cloud data of a scene where the object is located and pre-stored background point cloud data; a first determining subunit 112, configured to determine, if the scene point cloud data and the background point cloud data have same data, the same data in the scene point cloud data and the background point cloud data; and a removing subunit 113, configured to remove the same data from the scene point cloud data to obtain the point cloud data of the object.

Further, the obtaining unit 11 further includes: a first processing subunit 114, configured to perform downsampling processing on the point cloud data of the object to obtain points with the number being a first preset value; and a second processing subunit 115, configured to input the points with the number being the first preset value to the pre-trained point cloud neural network to obtain a predicted posture of the object to which at least one of the points with the number being the first preset value belongs.

Further, the predicted posture includes a predicted position. The second processing unit 13 includes: a dividing subunit 131, configured to divide the at least one point into at least one set according to the predicted position of the object to which the point in the at least one clustering set belongs to obtain the at least one clustering set.

Further, the dividing subunit 131 is further configured to: take any point from the point cloud data of the object as a first point; construct a first to-be-adjusted clustering set by taking the first point as the center of sphere and a second preset value as a radius; take the first point as a starting point and a point other than the first point in the first to-be-adjusted clustering set as an ending point to obtain first vectors, and sum the first vectors to obtain a second vector; and if a modulus of the second vector is less than or equal to a threshold, take the first to-be-adjusted clustering set as the clustering set.

Further, the dividing subunit 131 is further configured to: if the modulus of the second vector is greater than the threshold, move the first point along the second vector to obtain a second point; construct a second to-be-adjusted clustering set by taking the second point as the center of sphere and the second preset value as a radius; take the second point as a starting point and a point other than the second point in the second to-be-adjusted clustering set as an ending point to obtain third vectors, and sum the third vectors to obtain a fourth vector; and if a modulus of the fourth vector is less than or equal to the threshold, take the second to-be-adjusted clustering set as the clustering set.

Further, the third processing unit 14 includes: a calculating subunit 141, configured to calculate an average value of the predicted postures of the objects included in the clustering set; and a second determining subunit 142, configured to take the average value of the predicted postures as the posture of the object.

Further, the correcting unit 15 includes: a second obtaining subunit 151, configured to obtain a three-dimensional model of the object; a third determining subunit 152, configured to take an average value of the predicted postures of the objects to which the points included in the clustering set belong as a posture of the three-dimensional model; and an adjusting subunit 153, configured to adjust the position of the three-dimensional model according to an iterative closest point algorithm and the clustering set corresponding to the object, and take the posture of the three-dimensional model subjected to position adjustment as the posture of the object.

Further, the point cloud neural network is obtained based on a summed value of a point-by-point cloud loss function and backpropagation training; the point-by-point cloud loss function is obtained based on weighted superposition of a posture loss function, a classification loss function, and a visibility prediction loss function, the point-by-point cloud loss function is the sum of a loss function of the at least one point in the point cloud data, and the posture loss function is:

L=Σ∥R_{P}−R_{GT}∥²,

Where R_{P} is a posture of the object, R_{GT} is a tag of the pose, and Σ is the sum of a point cloud posture loss function of the at least one point in the point cloud data.

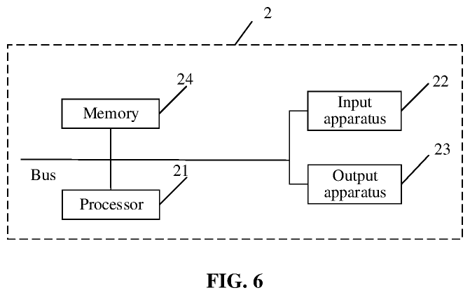

FIG. 6 is a schematic structural diagram of hardware of an object posture estimation apparatus provided in embodiments of the present disclosure. The estimation apparatus 2 includes a processor 21, and further includes an input apparatus 22, an output apparatus 23, and a memory 24. The input apparatus 22, the output apparatus 23, the memory 24, and the processor 21 are connected by means of a bus.

The memory includes, but is not limited to, a Random Access Memory (RAM), a Read-Only Memory (ROM), an Erasable Programmable Read Only Memory (EPROM), or a Compact Disc Read-Only Memory (CD-ROM), and the memory is configured to store related instructions and data.

The input apparatus is configured to input data and/or a signal, and the output apparatus is configured to output data and/or a signal. The output apparatus and the input apparatus may be independent devices, or may be an integrated device.

The processor may include one or more processors, for example, include one or more Central Processing Units (CPU). When the processor is a CPU, the CPU is a single-core CPU, or may be a multi-core CPU.

The memory is configured to store program codes and data of a network device.

The processor is configured to invoke the program codes and the data in the memory to perform the steps in the foregoing method embodiments. Reference is to the descriptions in the foregoing method embodiments for details. Details are not described herein again.

It can be understood that FIG. 6 merely illustrates a simplified design of an object posture estimation apparatus. In actual applications, an object posture estimation apparatus may further include other necessary elements, including, but not limited to, any number of input/output apparatuses, processors, controllers, memories, etc. Any descriptions that can achieve the object posture estimation apparatus in the embodiments of the present disclosure should all be included within the scope of protection of the present disclosure.

The embodiments of the present disclosure further provide a computer program product, configured to store computer-readable instructions, where when the instructions are executed, a computer performs the operations of the object posture estimation method according to any one of the foregoing embodiments.

The computer program product may be specifically implemented by means of hardware, software, or a combination thereof. In one optional embodiment, the computer program product is specifically reflected as a computer storage medium (including volatile and non-volatile storage media). In another optional embodiment, the computer program product is specifically reflected as a software product, such as Software Development Kit (SDK).

Persons of ordinary skill in the art may be aware that the individual exemplary units and arithmetic steps that are described in conjunction with the embodiments disclosed herein may be implemented by electronic hardware, or a combination of computer software and electronic hardware. Whether these functions are performed by hardware or software depends on the particular applications and design constraint conditions of the technical solutions. A person skilled in the art may use different methods to implement the described functions for each particular application, but it should not be considered that the implementation goes beyond the scope of the present disclosure.

A person skilled in the art can clearly understand that for convenience and brevity of description, reference is made to corresponding process descriptions in the foregoing method embodiments for the specific working processes of the system, the apparatus, and the units described above, and details are not described herein again.

It should be understood that the disclosed system, apparatus, and method in the embodiments provided in the present disclosure may be implemented by other modes. For example, the apparatus embodiments described above are merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by means of some interfaces. The indirect couplings or communication connections between the apparatuses or units may be electrical and mechanical, or in other forms.

The units described as separate parts may or may not be physically separate, and the parts displayed as units may or may not be physical units, may be located at one position, or may be distributed on a plurality of network units. A part of or all of the units may be selected according to actual needs to achieve the objectives of the solutions of the embodiments.

In addition, functional units in the embodiments of the present disclosure may be integrated into one processing unit, or each of the units may exist alone physically, or two or more units may be integrated into one unit.

The foregoing embodiments may be implemented in whole or in part by using software, hardware, firmware, or any combination of software, hardware, and firmware. When implemented by software, the embodiments may be implemented in whole or in part in the form of a computer program product. The computer program product includes one or more computer instructions. When the computer program instruction(s) is/are loaded and executed on a computer, the processes or functions in accordance with the embodiments of the present disclosure are generated in whole or in part. The computer may be a general-purpose computer, a special-purpose computer, a computer network, or other programmable apparatuses. The computer instruction(s) may be stored in or transmitted over a computer-readable storage medium. The computer instruction(s) may be transmitted from one website site, computer, server, or data center to another website site, computer, server, or data center in a wired (e.g., a coaxial cable, optical fiber, Digital Subscriber Line (DSL)) or wireless (e.g. infrared, wireless, microwave, etc.) manner. The computer-readable storage medium may be any available medium that can be accessed by a computer or a data storage device such as a server, a data center, or the like that includes one or more available media integrated thereon. The available medium may be a magnetic medium such as a floppy disk, a hard disk, a magnetic tape, an optical medium such as a Digital Versatile Disc (DVD), or a semiconductor medium such as a Solid State Disk (SSD), etc.

A person of ordinary skill in the art may understand that: all or some steps of implementing the forgoing method embodiments may be achieved by a program by instructing related hardware; the program may be stored in a computer-readable storage medium; when the program is executed, steps including the foregoing method embodiments are performed; moreover, the foregoing storage medium includes various media capable of storing program codes such as an ROM, an RAM, a magnetic disk, or an optical disk.

1. An object posture estimation method, the method comprising:
obtaining point cloud data of an object, wherein the point cloud data comprises at least one point;
inputting the point cloud data of the object into a pre-trained point cloud neural network to obtain a predicted posture of the object to which the at least one point belongs;
performing clustering processing on the predicted posture of the object to which the at least one point belongs to obtain at least one clustering set; and
obtaining a posture of the object according to predicted postures of at least one object comprised in the at least one clustering set, wherein the posture comprises a position and an attitude angle.

2. The method according to claim 1, wherein the posture of the object comprises a posture of a reference point of the object; and
the posture of the object comprises a position and an attitude angle of the reference point of the object, and the reference point comprises at least one of center of mass, center of gravity, or center.

3. The method according to claim 1, wherein for inputting the point cloud data of the object into the pre-trained point cloud neural network to obtain the predicted posture of the object to which the at least one point belongs, operations performed by the pre-trained point cloud neural network on the point cloud data of the object comprise:
performing feature extraction processing on the at least one point to obtain feature data; and
performing linear transformation on the feature data to obtain the predicted posture of the object to which the at least one point respectively belongs.

4. The method according to claim 3, wherein the predicted posture of the object comprises a predicted position and a predicted attitude angle of a reference point of the object; and
performing linear transformation on the feature data to obtain the predicted posture of the point to which the at least one point respectively belongs comprises:
performing first linear transformation on the feature data to obtain a predicted displacement vector that is from a position of the reference point of the object to which a point belongs to a position of the point;
obtaining a predicted position of the reference point of the object to which the point belongs according to the position of the point and the predicted displacement vector; and
performing second linear transformation on the feature data to obtain a predicted attitude angle of the reference point of the object to which the point belongs.

5. The method according to claim 4, wherein the pre-trained point cloud neural network comprises a first fully connected layer, and the performing first linear transformation on the feature data to obtain the predicted position of the object to which the at least one point respectively belongs comprises:
obtaining a weight of the first fully connected layer;
performing weighted superposition on the feature data according to the weight of the first fully connected layer to obtain the predicted displacement vector that is from the position of the reference point of the object to which the point belongs to the position of the point; and
obtaining the predicted position of the reference point of the object to which the point belongs according to the position of the point and the predicted displacement vector.

6. The method according to claim 4, wherein the pre-trained point cloud neural network comprises a second fully connected layer, and the performing second linear transformation on the feature data to obtain the predicted attitude angle of the object to which the point belongs comprises:
obtaining a weight of the second fully connected layer; and
performing weighted superposition on the feature data according to the weight of the second fully connected layer to obtain predicted attitude angles of the object to which the point belongs.

7. The method according to claim 1, wherein obtaining the point cloud data of the object comprises:
obtaining scene point cloud data of a scene where the object is located and pre-stored background point cloud data;
if the scene point cloud data and the background point cloud data have same data, determining the same data in the scene point cloud data and the background point cloud data; and
removing the same data from the scene point cloud data to obtain the point cloud data of the object.

8. The method according to claim 7, further comprising:
performing downsampling processing on the point cloud data of the object to obtain points with an amount of a first preset value; and
inputting the points with the amount of the first preset value to the pre-trained point cloud neural network to obtain a predicted posture of the object to which at least one of the points with the amount of the first preset value belongs.

9. The method according to claim 1, wherein the predicted posture comprises a predicted position, and performing clustering processing on the at least one point to obtain the at least one clustering set comprises:
dividing the at least one point into at least one set according to the predicted position of the object to which the at least one point in the at least one clustering set belongs, to obtain the at least one clustering set.

10. The method according to claim 1, wherein dividing the at least one point into at least one set according to a predicted position of the object to which the at least one point in the at least one clustering set belongs, to obtain the at least one clustering set comprises:
taking one point from the point cloud data of the object as a first point;
constructing a first to-be-adjusted clustering set by taking the first point as center of sphere and a second preset value as a radius;
obtaining at least one first vector by taking the first point as a starting point and at least one point other than the first point in the first to-be-adjusted clustering set as an ending point, and summing the at least one first vector to obtain a second vector; and
taking, if a modulus of the second vector is less than or equal to a threshold, the first to-be-adjusted clustering set as the at least one clustering set.

11. The method according to claim 10, further comprising:
if the modulus of the second vector is greater than the threshold, moving the first point along the second vector to obtain a second point;
constructing a second to-be-adjusted clustering set by taking the second point as center of sphere and the second preset value as a radius;
obtaining at least one third vector by taking the second point as a starting point and at least one point other than the second point in the second to-be-adjusted clustering set as an ending point, and summing the at least one third vector to obtain a fourth vector; and
if a modulus of the fourth vector is less than or equal to the threshold, taking the second to-be-adjusted clustering set as the at least one clustering set.

12. The method according to claim 1, wherein obtaining the posture of the object according to the predicted postures of the at least one object comprised in the at least one clustering set comprises:
calculating an average value of the predicted postures of the at least one object comprised in the at least one clustering set; and
taking the average value of the predicted postures as the posture of the object.

13. The method according to claim 1, further comprising:
correcting the posture of the object and determining the corrected posture as the posture of the object.

14. The method according to claim 13, wherein correcting the posture of the object and determining the corrected posture as the posture of the object comprises:
obtaining a three-dimensional model of the object;
taking an average value of the predicted postures of the objects to which points comprised in the clustering set belong as a posture of the three-dimensional model; and
adjusting the position of the three-dimensional model according to an iterative closest point algorithm and the clustering set corresponding to the object, and determining the posture of the three-dimensional model subjected to position adjustment as the posture of the object.

15. The method according to claim 1, further comprising:
inputting the point cloud data of the object to the pre-trained point cloud neural network to obtain a category of the object to which the at least one point in the point cloud data belongs.

16. The method according to claim 1, wherein the pre-trained point cloud neural network is obtained based on a summed value of a point-by-point cloud loss function and backpropagation training; the point-by-point cloud loss function is obtained based on weighted superposition of a posture loss function, a classification loss function, and a visibility prediction loss function, and the point-by-point cloud loss function is summation of a loss function of the at least one point in the point cloud data.

17. An object posture estimation apparatus, the apparatus comprising:
a processor; and
a memory configured to storing executable by the processor,
wherein the processor is configured to:
obtain point cloud data of an object, wherein the point cloud data comprises at least one point;
input the point cloud data of the object into a pre-trained point cloud neural network to obtain a predicted posture of the object to which the at least one point belongs;
perform clustering processing on the predicted posture of the object to which the at least one point belongs to obtain at least one clustering set; and
obtain a posture of the object according to predicted postures of at least one object comprised in the at least one clustering set, wherein the posture comprises a position and an attitude angle.

18. The apparatus according to claim 17, wherein the processor is further configured to:
perform feature extraction processing on the at least one point to obtain feature data; and
perform linear transformation on the feature data to obtain the predicted posture of the object to which the at least one point respectively belongs.

19. The apparatus according to claim 18, wherein the predicted posture of the object comprises a predicted position and a predicted attitude angle of a reference point of the object; and
the processor is further configured to:
perform first linear transformation on the feature data to obtain a predicted displacement vector of a position of the reference point of the object to which the point belongs to a position of the point;
obtain a predicted position of the reference point of the object to which the point belongs according to the position of the point and the predicted displacement vector; and
perform second linear transformation on the feature data to obtain a predicted attitude angle of the reference point of the object to which the point belongs.

20. A non-transitory computer-readable storage medium having a computer program stored thereon, wherein the computer program comprises program instructions that, when being executed by a processor, cause the processor to execute the following operations:
obtaining point cloud data of an object, wherein the point cloud data comprises at least one point;
inputting the point cloud data of the object into a pre-trained point cloud neural network to obtain a predicted posture of the object to which the at least one point belongs;
performing clustering processing on the predicted posture of the object to which the at least one point belongs to obtain at least one clustering set; and
obtaining a posture of the object according to predicted postures of at least one object comprised in the at least one clustering set, wherein the posture comprises a position and an attitude angle.
